(19) United States
(12) Patent Application Publication
(10) Pub. No.: US 2008/0148587 A1
(43) Pub. Date: Jun. 26, 2008

(54) Pine fitters square

(76) Inventor: Harry R. Goodrich, (US)

Correspondence Address: Harry R. Goodrich JR., 18769 Jolly Rd., Burlington, WA, 98233, US

(21) Appl. No.: 11/645,336

(22) Filed: Dec. 26, 2006

(51) Int. Cl. G01B 1/00

(52) U.S. Cl. 33/529

(57) ABSTRACT

A squaring tool used by pipe fitters in lay out and angular orientation and welding of pipe segments and pipe elbows comprises a rugged one piece tool wherein a long tang and a short tang are interconnected at their ends by a large radius corner allowing squaring and alignment of pipe components from either the inside or outside of the angle formed by the pipe segments and elbows.

### BACKGROUND OF THE INVENTION

The following invention relates to a pipe fitters tool used in the fabrication of welded joints and more particular, an improved rugged and inexpensive lay out square used for the proper alignment and angular orientation of pipe segments and welded elbows.

In the field of pipefitting and the fabrication of tubular type forms a number of complications present themselves due to the operational environment where the work is to be completed. There are instances where complex segments of pipe can be completed in a shop environment or at a station where the pipe welder may have access to jig tables or fixturing tooling whereby pipe joints or welded attachment of elbows or angular pipe members can be laid out as specified; and secured in the proper position relative to one another enabling the pipe fabricator to complete the welding operation quickly, easily and accurately. It is a more common operational procedure however when required to weld or fabricate large tubing or pipe members, that the work be completed “on sight”, where there is usually insufficient room for cumbersome set up or fixturing tooling. In a ships engine room for example there are countless runs of pipe and large tubular sections which must pass through any number of compartments or enclosed areas wherein great accuracy is still required in the welded joining of each and every segment without the convenience ease and accuracy of extensive jigs or fixtures made available to welders and fabricators in the aforementioned shop environment.

Although there a number of ways and means to fabricate pipe to conform to the many angles or turns that might be required, one of the most common is by the welded assembly of accurately pre-manufactured elbows or angled sections. In a case for example where a 90 degree elbow might be required, It is of the utmost importance that the straight pipe sections welded on either end of the 90 degree elbow be welded in a manner wherein the axial centerline of the elbow inlet and outlet openings is aligned with the axial centerline of each of the pipe segments joined to the 90 degree elbow. During this stage of the process, it is helpful to be able to temporarily “tack” weld the components to be joined while continuing to monitor the overall alignment of the pipe and elbow segments insuring that final alignment and welding conforms to specifications. It is important to keep in mind that pre manufactured welding elbows come in a number sizes as well as geometric configurations. There are reducing elbows, wherein each of the ends of the elbow to be joined to their respective pipe segments are of a different diameter, and “3 R” elbows; which are also commonly used wherein the overall radius of the of the elbow is greater than what might be considered a “standard” radius elbow.

No matter what configuration or size elbow might be required, the necessity for accuracy and very high integrity welds in the fabrication of welded joints is foremost and a fundamental key to producing quality welded joints lies in joint preparation and the proper alignment of pipe components to be joined. The fact remains that without proper tools to aid in the necessary proper set up of welded joints prior to the final welding, fabrication of pipe components as outlined herein becomes extremely time consuming.

In reviewing prior art, there have been a number of tools presented that have attempted to address the aforementioned problem as outlined.

Mr. Hamilton's Angularly Adjustable Square U.S. Pat. No. 3,670,418 presents an instrument arranged to line up pipe segments prior to welding. Although Mr. Hamilton's tool is fully adjustable for angle and is of a design that would not be affected by the various elbow configurations outlined earlier, it is limited to squaring work on inside corners only. The adjustable style-squaring tool also lacks the simple ruggedness of the proposed invention due to its many “movable components and considerably more delicate construction.

Another work is U.S. Pat. No. 4,095,346, Mr. Cox's Pipefitting Square. Although this invention addresses the need for a simple means of angularly orienting pipe components prior to welding, it lacks provision to square radiused corners, such as is encountered with manufactured welding elbows, from inside the angle formed by the elbow. As this square is not radiused at the corner there is no provision for the accurate locating or placement of the tool directly against an inside corner of pipe segments without interference between the inside radius of the elbow and the corner of the square. This squaring tool appears to be designed primarily to provide information aiding in the completion of complicated calculations as might be required for laying out the various sizes of pipe diameters prior to the welding process.

U.S. Pat. No. 4,138,819, Mr. Sosin's Outside Corner Square addresses in part a desirability for a clearance or relief at the actual intersection of the two squaring arms or blades. Although this tool is not intended to be utilized for the same purpose as the invention outlined herein, it is included to emphasize the advantages of the concept of “relieved corners” in specialized squaring instruments or tools.

### SUMMARY OF THE INVENTION

The present invention overcomes a number of the pipe fitters squaring and layout problems related to welding pipe elbows in that it is a rigid one piece tool that can be utilized for squaring from both the inside of the angle formed by the elbow, or outside of the angle of the pipe segments to be joined. The invention as disclosed is provided for with geometry allowing for the necessary clearance and placement of the square directly against the pipe segments to be angularly aligned while the tacking or welding process is being carried out regardless of the elbow style or configuration. The proposed tool is also rigid enough to be clamped or otherwise fixed to pipe segments if required without possibilities of coming out of angular adjustment due to the simple one piece construction rugged enough to withstand the harsh environments that many “on site” work locations present.

The primary object of the this invention to provide a simple inexpensive tool designed to simplify lay out and alignment of pipe segments when segments are joined by welding to various types of manufactured elbow configurations.

It is a further objective to provide a tool that can be utilized for accurate layout of angular welded pipe connections from either the inside or the outside of the angle formed by the pipe and elbows.

It is a further objective of the invention to provide a squaring tool with unique geometry allowing it to be utilized while preliminary and or temporary welding tacks are being applied.

Another objective of the proposed invention is to provide an extremely rugged one piece layout tool that can be used reliably in dirty or harsh confines as commonly present in “on site” work environments.

Various other objects and advantages of the proposed invention will become fully apparent in the following description of the drawings which will illustrate a preferred embodiment wherein,

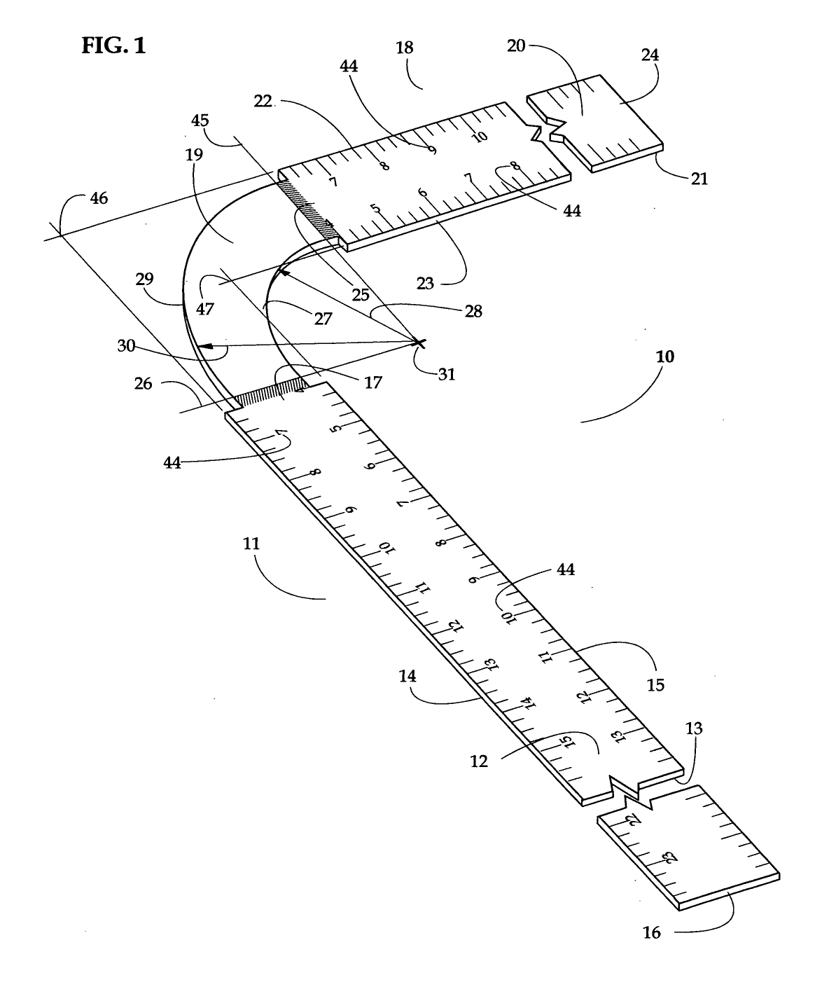

FIG. 1 discloses the general configuration of the pipe fitters square.

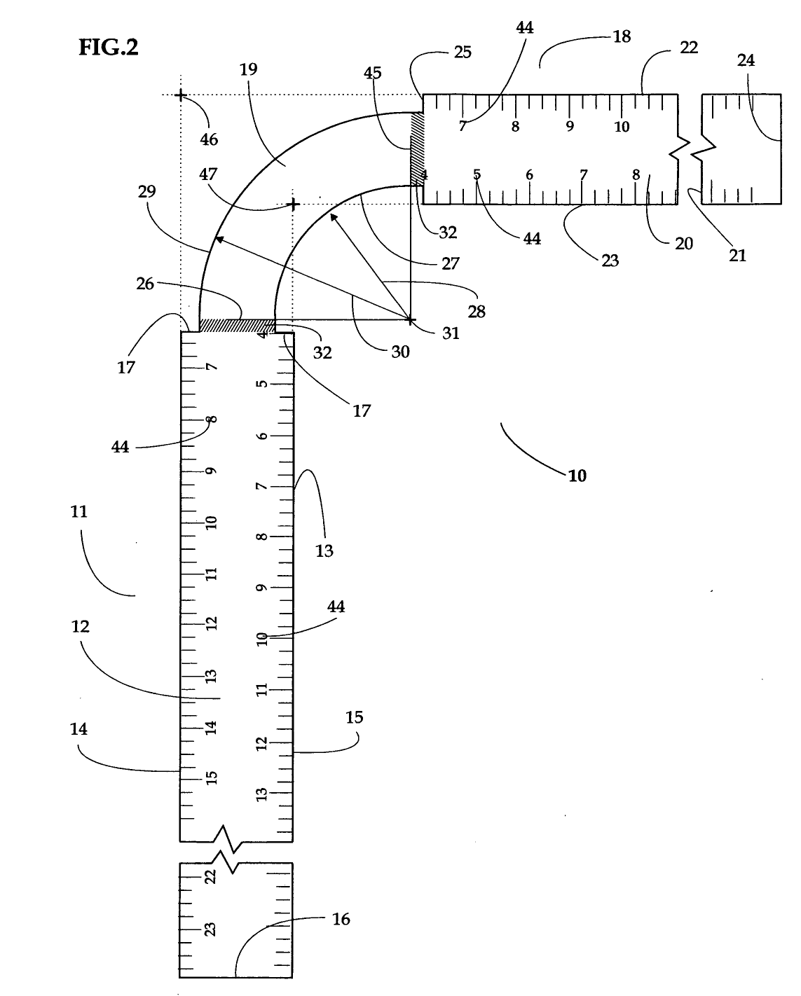

FIG. 2 defines basic dimensional geometry of the pipe fitters square.

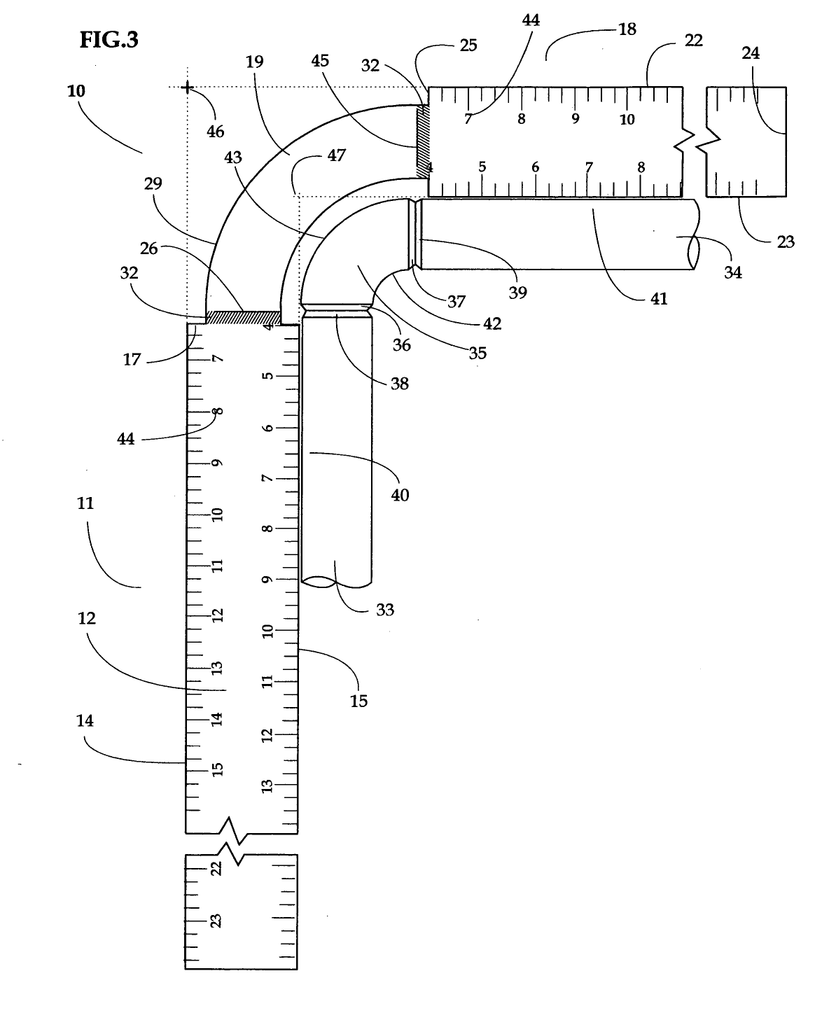

FIG. 3 shows squaring application from “outside angle”.

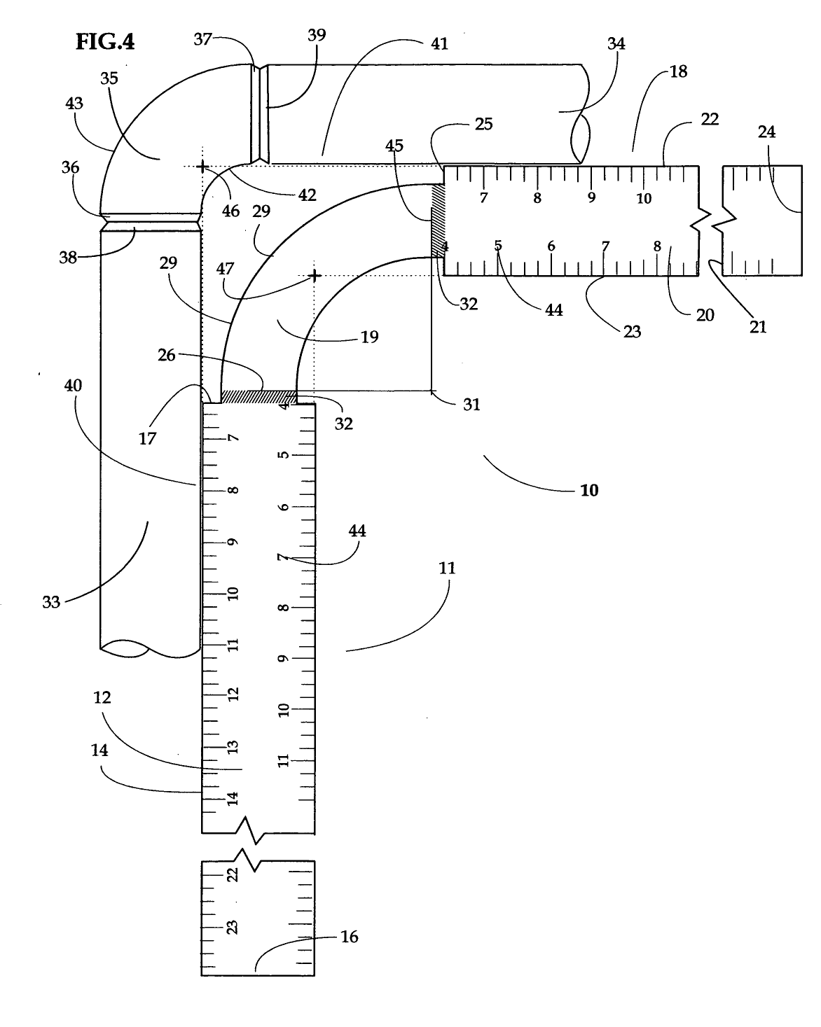

FIG. 4 shows squaring application from “inside angle”.

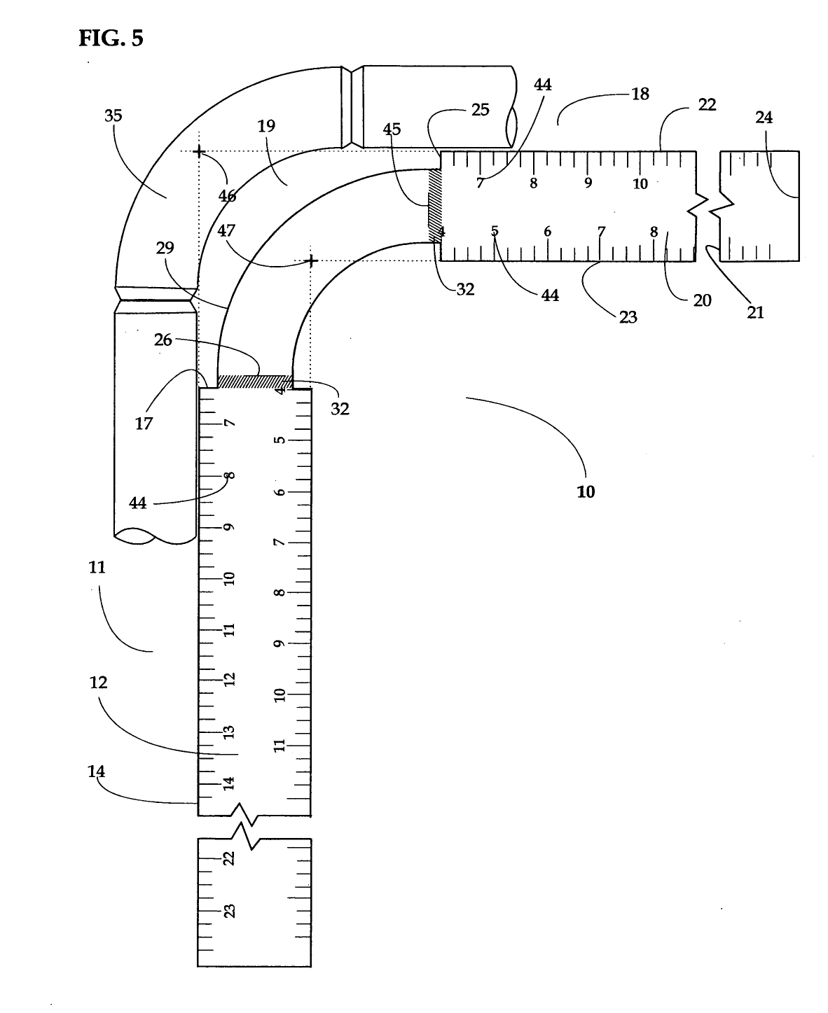

FIG. 5 shows “inside angle” squaring application of large radius elbow.

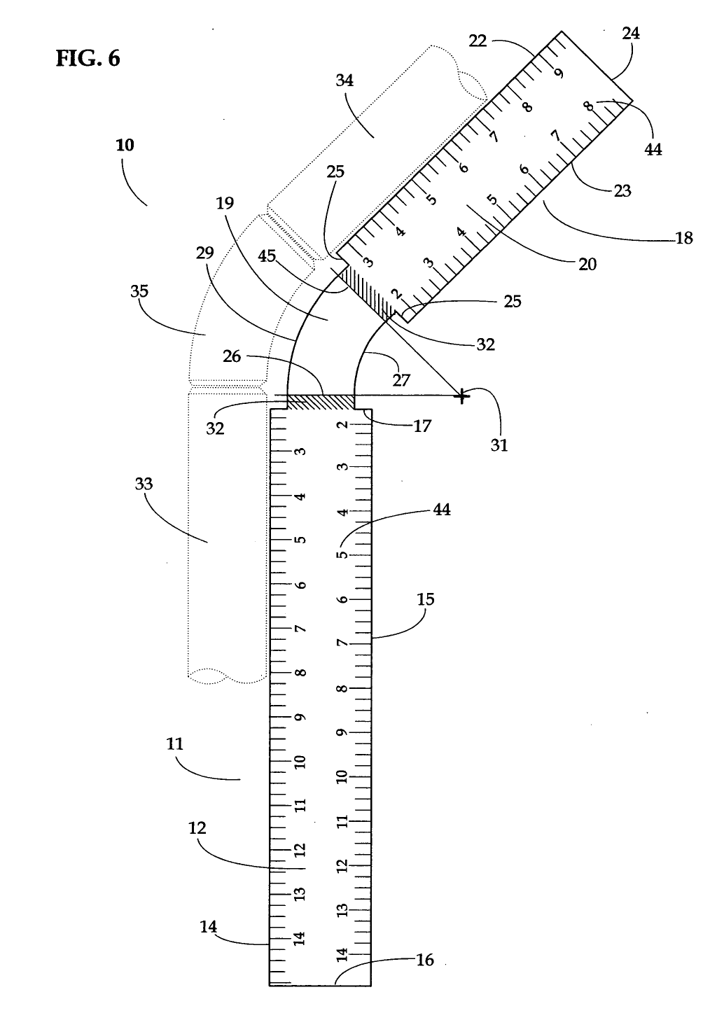

FIG. 6 shows 45 degree configuration of pipe fitters square.

### DETAILED DESCRIPTION

Reference FIG. 1 showing an illustration of the disclosed invention wherein Pipe fitters square (10) is manufactured as a fabricated or stamped component of metallic material having resilient characteristics. Pipe fitters square (10) comprises a generally rectangular shaped long tang (11) having a front face (12) a back face (13), an outside edge (14) an inside edge (15), a free end (16) and a shouldered end (17). Long tang (11) of pipe fitters square (10) as disclosed in this preferred embodiment has a length measured between shouldered end (17) and free end (16) of long tang (11) equaling approximately 17⅝″. The width of long tang (11) measured between inside edge (15) and outside edge (14) is approximately 2-0″ and the thickness of tang (11), measured between back face (13) and front face (12) of long tang (11) is approximately 0.125″. A geometrically similarly shaped short tang (18) is substantially joined to long tang (11) by a 90 degree radiused segment referred to as a corner tang (19). Short tang (18) has a length measured between shouldered end (25) and free end (24) of short tang (18) equaling approximately 9⅝″. The approximate width of short tang (18), measured between inside edge (23) and outside edge (22) is approximately 2-0″ and the thickness of short tang (18) measured between back face (21) and front face (20) of short tang (18) of approximately 0.125″. Long tang (11) and short tang (18) of pipe fitters square (10) are substantially connected and arranged at a 90-degree angle to each other by corner tang (19). Corner tang (19) is defined as a quadrant of a circle segment having a first end (26), a second end (45), a major radius (30), identifying outside edge (29) and a minor radius (28) which identifies inside edge (27) of corner tang (19).

As pipe fitters square (10) may be produced in different sizes, it is important to note that a specific relationship between the length of long tang (11) and major radius (30) of corner tang (19) exists wherein major radius (30) will always be approximately ⅓ the length of long tang (11) measured between free end (16) and shouldered end (17) of long tang (11). To enable the user to square and reference from either side of pipe fitters square (10), both front face (12) and back face (13) of long tang (11) are provided for with indicia (44) for general referencing of pipe segments lengths. Front face (20) and back face (21) of short tang (18) are also provided for with indicia (44) enabling general referencing of pipe segment lengths from either side of pipe fitters square (10)

### Referencing FIG. 2

Showing additional detailed geometry of Pipe fitters square (10) wherein corner tang (19) which substantially joins long tang (11) and short tang (18) is integral to long tang (11) and short tang (18) and therefore has the same thickness dimension of approximately 0.125″ as long tang (11) and short tang (18). Corner tang (19) geometry comprises a quadrant of a circular segment whose ends (26) and (45) are arranged at approximately 90 degrees to one another wherein inside edge (27) of corner tang (19) is generated by minor radius (28) which measures approximately 4¼″ in length. Outside edge (29) of corner tang (19) is generated by major radius (30) measuring approximately 5¾″ in length. Center point (31) is the point at which lines extended from end (26) of corner tang (19) and end (45) of corner tang (19) would intersect. Center point (31) is also the point from which minor radius (28) and major radius (30) is generated. The width of corner tang (19) measured between inside edge (27) and outside edge (29) of this preferred embodiment is approximately 1½″.

Relief (32) is created by notching outside edge (14) and inside edge (13) of shouldered ends (17) of long tang (11) and outside edge (22) and inside edge (23) of shouldered ends (25) of short tang (18) for a distance of approximately ¼″. Relief (32) provides for additional clearance and access between inside edge (27) of corner tang (19) and convex surface (43) of elbow (35) (as shown in FIG. 3), or outside edge (29) of corner tang (19) and concave surface (42) of elbow (35) (as shown in FIG. 4), depending upon an inside angle or outside angle working position of pipe fitters square (10) relative to elbow (35).

### Returning Again to FIG. 2

For the purpose of description, corner (46) is the point wherein ghost lines carried out from outside edge (14) of long tang (11) and outside edge (22) of short tang (18) of pipe fitters square (10) would intersect. Corner (46) serves as the zero or start point for indicia (44) graduations for both outside edge (14) of long tang (11) and outside edge (22) of short tang (18) on the disclosed preferred embodiment of pipe fitters square (10). Graduation marks for indicia will follow a ¼″ format or four marks to the inch. Shouldered end (17) of long tang (11) and shouldered end (25) of short tang (18) each lie approximately 6.375″ from corner (46). As the distance between shouldered end (17) or shouldered end (25) and the first whole number representing 7″ from corner (46) is approximately ⅝″. Subsequent graduations of indicia on long tang (11) and short tang (18) will reflect that indicia (44) pattern.

Inside corner (47) is the point wherein ghost lines carried out from inside edge (15) of long tang (11) and inside edge (23) of short tang (18) of pipe fitters square (10) would intersect. Inside corner (47) serves as the zero or start point for indicia (44) graduations for both inside edge (15) of long tang (11) and inside edge (23) of short tang (18) on the disclosed preferred embodiment of pipe fitters square (10). Graduations for indicia will follow a ¼″ format or four marks to the inch. Shouldered end (17) of long tang (11) and shouldered end (25) of short tang (18) each lie approximately 4-0″ from corner (47). The distance between shouldered end (17) measured at inside edge (15) of long tang (11) and inside corner (47), and shouldered end (25) measured at inside edge (23) of short tang (18) and inside corner (47) each equals approximately 4-0″. Therefore, the first whole number representing distance from inside corner (47) will be number 4. subsequent graduations of indicia will reflect this format.

Point (46) is further identified as shown in FIG. 4 to illustrate as how major radius (30) defining outside edge (29) of corner tang (19) eliminates the possibility of interference between outside edge (29) of pipe fitters square (10) and concave surface (42) of elbow (35).

Reference now FIG. 3 wherein an illustration of how pipe fitters square (10) is provided for with clearance relief's (32) at ends (26) and (45) on corner tang (19). Clearance relief (32) allows squaring from outside surface (40) of pipe segment (33) to outside surface (41) of pipe segment (34) while maintaining sufficient clearance for tack welding between inside edge (15) of long tang (11) and inside edge (23) of short tang (18) and, chamfered end section (38) of pipe segment (33) and chamfered end section (39) on pipe segment (34) are to be joined with a typical chamfered end type 90 degree elbow (35) and where chamfered end (36) of 90 degree elbow (35) is to be positioned and welded to end section (38) on pipe segment (33) and chamfered end (37) of 90 degree elbow (35) is to be welded to chamfered end section (39) on pipe segment (34).

Referencing FIG. 4 showing pipe fitters square (10) squaring pipe segment (33) to pipe segment (34) from the inside of the 90 degree angle of elbow (35) wherein outside edge (22) of short tang (18) on pipe fitters square (10) can be positioned substantially against of surface (41) of pipe segment (34) and outside edge (14) of long tang (11) of pipe fitters square (10) can be positioned substantially against surface (40) of pipe segment (33) without interference between concave surface (42) of elbow (35) and outside edge (29) of corner tang (19) or, interference between chamfered end section (38) of pipe segment (33) or chamfered end section (39) of pipe section (34), or with chamfered ends (36) and (37) of elbow (35) and inside edge (29) of corner tang (19).

Note. It should be noted here that 90 degree elbow (35), as illustrated in FIG. 3 and FIG. 4 is shown for the purpose of clarity. Pipe fitter's square (10) as disclosed will accommodate a plurality of radius' and styles of elbow incorporating different geometry as shown in FIG. 5 wherein elbow (35) having a substantially larger radius is disclosed

Referencing FIG. 6 Although pipe fitters square (10) is characterized in the 90 degree geometry with a long tang (11) of approximately 17¾″ in length for the foregoing preferred embodiment, pipe fitters squares could be produced in an infinite number of sizes and configurations to accommodate an infinite number of angles of welded elbows (35).

In this illustration, ghost lines depicting a 45 degree elbow and corresponding pipe segments arranged for welding wherein a 45 degree version of pipe fitters square (10) with long tang (11) being approximate 12″ long. Basic components number assignments for description and provisions of the pipe fitters square (10) remain as disclosed in the preferred embodiment with the exception tang long (11) and short tang (18) length, width and wherein corner tang (19) is arranged to accommodate a smaller version of elbow (35) in a 45 degree configuration.

Based upon the forgoing description it will be apparent that an improved pipe fitters squaring device has been disclosed providing for monitoring of the desired angular requirements while actual welding of pipe components is in process, and wherein relief's and clearances incorporated into the design of the squaring tool allow for unrestricted angular alignment of pipe components during the welding and assembly process.

While the present invention has been described according to a particular specific embodiment, numerous modifications to the invention are possible without falling away from the spirit and scope of the invention as described by the following appended claims.

What is claimed is:

1. A generally rigid one piece squaring tool for use in angular alignment in welding of pipe elbow components wherein said squaring tool comprises a long tang having two opposing ends defining length there between, where in cross sectional geometry of said long tang comprises an inside edge and outside edge defining width there between and a front face and a back face defining thickness there between and wherein said long tang is interconnected to a short tang having two opposing ends defining length there between, and cross sectional geometry of said short tang comprises an inside edge and an outside edge defining width there between and a front face and a back face defining thickness there between and where in an interconnecting means of one end of said two opposing ends of said long tang and one end of said two opposing ends of said short tang provided by a radiused segment 90 degree corner tang having a first end and a second end and where in geometry of said 90 degree corner tang is generated by a minor radius defining an inside edge of said 90 degree corner tang and a major radius defining an outside edge of said 90 degree corner tang with the difference between said outside edge and said inside edge defining width of said 90 degree corner tang there between, and wherein outside radius of said 90 degree corner tang is equal to approximately ⅓^{rd} the length of said long tang, and, where in a front and back face said 90 degree corner tang defines thickness there between of and wherein said first end of said 90 degree corner tang is substantially interconnected to said end of said short tang and said second end of said 90 degree corner tang is substantially interconnected to said end of said long tang where in said short tang is geometrically perpendicular to said long tang.

2. A rigid one piece squaring tool as outlined in claim 1 wherein diminished width of said 90 degree corner tang provides for clearance relief shoulders at the point where said outside edge of said first end of said 90 degree corner tang joins said outside edge of said long tang and said outside edge of said second end of said 90 degree corner tang joins said outside edge of said short tang.

3. A rigid one piece-squaring tool as outlined in claim 2 wherein said outside edge of said face of said long tang and said outside edge of said face of said short tang are provided for with markings associated with numerical indicia corresponding to linear measurement.

4. A rigid one piece squaring tool as defined in claim 3 wherein angular geometry of said 90 degree corner tang is arranged as a 45 degree corner tang and said long tang is arranged at an angle of 45 degrees to said short tang.

5. A modified squaring tool adapted for squaring outside or inside radius corners comprises a generally rectangular long tang and a generally rectangular short tang where in said long tang and said short tang are interconnected by a radiused segment where by said radiused segment maintains angular relationship between said long tang and said short tang of approximately 90 degrees and wherein a dimensional relationship exists between said radiused segment and said long tang where in radius of said radiused segment shall equal approximately ⅓^{rd} the length of said long tang.

6. The modified squaring tool set forth in claim 5 wherein said generally rectangular long tang and said generally rectangular short tang are integrally joined at an angle other than said 90 degrees by said radiused segment.

7. An improved rigid one piece tool arranged for use in angular alignment and preparation for welding radiused pipe elbows and intersecting pipe segments from either the outside or inside corner of the angle formed by said radiused pipe elbows and said pipe segments wherein said improved rigid one piece layout tool comprises a generally rectangular long tang and a generally rectangular short tang and wherein said generally rectangular long tang and said generally rectangular short tang retain an angular relationship to each other through an integral radiused corner segment.

8. A one piece tool as set forth in claim 7 wherein said radiused corner segment retains angular relationship of 90 degrees between said generally rectangular long tang and said generally rectangular short tang.

9. A one piece tool as set forth in claim 7 wherein said radiused corner segment retains angular relationship of 45 degrees between said generally rectangular long tang and said generally rectangular short tang.
